(19) United States
(12) Patent Application Publication
(10) Pub. No.: US 2008/0234154 A1
(43) Pub. Date: Sep. 25, 2008

(54) ORGANIC TUNGSTEN COMPLEXES

(75) Inventor: David Boudreau, Ansonia, CT (US)

Correspondence Address: NORRIS, MCLAUGHLIN & MARCUS, P.A., 875 THIRD AVE, 18TH FLOOR, NEW YORK, NY, 10022, US

(73) Assignee: R.T. VANDERBILT COMPANY, INC., NORWALK, CT (US)

(21) Appl. No.: 12/052,390

(22) Filed: Mar. 20, 2008

Related U.S. Application Data
(60) Provisional application No. 60/895,792, filed on Mar. 20, 2007.

(51) Int. Cl. C10M 107/40; C07F 11/00

(52) U.S. Cl. 508/367; 556/57

(57) ABSTRACT

The present invention relates to lubricant compositions containing phosphorus and sulfur free organotungstates. The organotungstates are defined as either the reaction product of a mono- or diglyceride and a tungsten source, or as the reaction product of a secondary amine, a fatty acid derivative, and a tungsten source. These compositions exhibit improved antiwear, corrosion, and antioxidancy properties, particularly in low phosphorus and low sulfur environments.

### FIELD OF THE INVENTION

The present invention relates to lubricant compositions imparting improved antiwear, corrosion, and antioxidancy properties. These compositions contain an organic tungsten complex which is defined as either the reaction product of a mono- or diglyceride and a tungsten source, or as the reaction product of a secondary amine, a fatty acid derivative, and a tungsten source.

### BACKGROUND OF THE INVENTION

Zinc dialkyldithiophosphates (ZDDP) have been added to lubricant compositions for decades due to their low cost, and ability to act as a multifunctional additives—possessing antiwear, and antioxidant properties. Despite the great benefit of these materials, it is well known that the sulfur and phosphorus from these compounds volitilize and pass through the exhaust systems of internal combustion engines where they inevitably poison catalytic converters.

One method to minimize the amount of sulfur and phosphorus reaching the catalytic converter is to reduce the amount of ZDDP present in the lubricant composition. In doing so, it is necessary to increase the amount of other additives to compensate for the antioxidant and antiwear functionality lost by the decrease or removal of ZDDP.

There are a multitude of examples in the patent literature where ZDDP concentrations are either reduced or eliminated. In these examples, the term “low phosphorus” is often used, but as this is a relative term, it may include phosphorus levels as high as 1000 ppm P. Therefore it is necessary in the following discussion to define a “low phosphorus” composition as any lubricant composition containing a phosphorus level below 600 ppm P. This is a minimum performance standard requirement, as set for an ILSAC GF-4 passenger car motor oil. The terms “zero phosphorus”, “no phosphorus”, or “phosphorus free” are defined herein as phosphorus concentrations less than or equal to 10 ppm P.

For the purpose of this discussion, a “low sulfur” composition is defined as any lubricant composition containing a sulfur level below 500 ppm S. This is defined as the minimum sulfur content required of an ILSAC GF-4 SAE 0W or SAE 5W grade motor oil.

Zero phosphorus lubricant formulations which maintain an acceptable level of wear have been demonstrated through the addition of a complex blend of phosphorus free antiwear additives, ashless friction reducers, extreme pressure additives, antioxidants, detergents and polymeric viscosity modifiers and flow improvers, as exemplified in U.S. Pat. Nos. 5,346,635, and 5,439,605. These examples are not low sulfur formulations, as defined above.

Low phosphorus or zero phosphorus lubricant formulations having acceptable wear have been demonstrated with the addition of detergents, as exemplified in U.S. Pat. Nos. 6,159,911, 6,784,143, and U.S. Pat. App. No. 2007/0049507. These examples are not low sulfur formulations, as defined above.

Low phosphorus lubricant formulations having acceptable wear have been demonstrated with the addition of an organomolybdenum dithiocarbamate compound, as exemplified in U.S. Pat. Nos. 6,500,786, and 6,852,679. These are not low sulfur formulations, as defined above.

Low phosphorus lubricant formulations having acceptable wear have been demonstrated with the addition of ashless compounds, such as sulfurized olefins (U.S. Pat. Nos. 4,330,420, and 6,884,855) and dithiocarbamates (U.S. Pat. Nos. 4,758,362, 6,852,680, and 7,160,845). These are not low sulfur formulations, as defined above.

Low phosphorus lubricant formulations having acceptable wear have been demonstrated using borated succinimide dispersants, as exemplified by U.S. Pat. Nos. 7,122,508. These are not low sulfur formulations, as defined above.

A zero phosphorus, low sulfur lubricant composition and method of use is described in U.S. Pat. No. 6,588,393 where a continuously fresh stream of lubricant is added to a running engine and the equivalent amount of used oil is removed and combined with the fuel stream. This is a unique system designed to reduce NOₓ emissions. Properties, such as wear, and friction are not considered.

It has now been discovered that a phosphorus and sulfur free organic tungsten complex may be employed in a lubricant composition containing no phosphorus and no sulfur. The organotungstate provides excellent antiwear and limits oxidation and corrosion. The organotungstate also proves effective in lubricant compositions where phosphorus and sulfur are present.

The patent literature contains several examples of tungsten being used in lubricant compositions. For instance, the use of ammonium tungstate salts, also referred to as oxytungstate salts, in aqueous environments is known. In particular, U.S. Pat. Nos. 4,626,367, and 4,816,303, and World Patent Application WO2008/013534 disclose how simple alkali earth tungsten salts may be employed as aqueous corrosion inhibitors. Tungstate salts have also been used as antioxidants in aqueous tin electroplating systems, as disclosed in U.S. Pat. Nos. 5,378,347, and 7,151,049.

Tungsten salts have been employed in nonaqueous base lubricant compositions as well. Simple inorganic salts of tungsten may be dispersed in grease and oil compositions, to be used as corrosion inhibitors, as exemplified in U.S. Pat. Nos. 6,010,984, 6,010,985, 6,017,857, 6,316,392, 6,331,509, 6,534,450, 6,632,781, 6,737,387, 6,858,160, and 7,265,080.

Oil and grease soluble tungstate salts have been prepared, most commonly through the incorporation of alkylammonium cations as exemplified in U.S. Pat. No. 4,298,485. U.S. Patent Application Nos. 2004/0214731, 2007/0203032, 2007/0203033, and 2007/0042917 describe lubricant compositions containing alkylammonium polyoxotungstates as antioxidant agents. Further, U.S. Pat. No. 3,290,245 discloses the use of an oil soluble alkylammonium polyoxotungstate salt as a detergent and dispersant of cold sludge, and as a friction reducer when combined with a sulfur source (i.e. ZDDP).

U.S. Pat. No. 2,795,549 discloses the potential use of oil soluble ammonium 4-t-butyl catechol vanadate and tungstate salts, as copper and lead corrosion inhibitors. More complex salts of tungsten may also be employed in lubricant compositions, such as the polycarboxylate salts of U.S. Pat. Nos. 5,321,146, 5,641,472, and 5,629,435. The tungsten complex used in the lubricating composition of this invention is not a tungstate salt, and is therefore not analogous to tungstate salts.

There are several references in the patent literature to other organotungsten compounds being used in lubricant compositions, which are not tungstate salts. For example, tungsten carboxylates such as that claimed, but not taught, in U.S. Pat. No. 4,824,611, could be employed in non-aqueous lubricant systems. U.S. Pat. No. 3,234,129 discloses a lubricating composition containing either an oil soluble diarene tungsten tricarbonyl, arene tungsten, or a dichlorotetranaphthyloxy tungsten which is effective as an antiwear additive, but only when combined with ZDDP. U.S. Pat. No. 6,211,123 describes the use of an oil soluble trinuclear thiotungstate for antiwear, antioxidant and friction control in a lubricant composition. U.S. Pat. Nos. 4,529,526, and 4,171,558 claim lubricating composition containing a zinc, molybdenum or tungsten dialkyldithiophosphate as antiwear agents, but only teach zinc and molybdenum. U.S. Pat. Nos. 3,068,259 and 3,193,500 described an extreme pressure lubricant containing a tungsten dialkyldithiophosphate which must be prepared from tungsten pentachloride.

Tungsten dithiocarbamates and their use in lubricant compositions are also known. U.S. Pat. No. 4,846,983 declares the synthesis of a tungsten dithiocarbamate from WO₃ but contains neither data confirming that the complex was formed, nor does it exemplify a lubricant composition containing the organic tungsten complex according to an embodiment of the present invention. Other preparations of tungsten dithiocarbamates, such as those in U.S. Pat. Nos. 5,308,519, and 6,211,123 and World Patent Application WO2004/043910, teach the synthesis of various tungstates by either the use of expensive starting materials and reagents, or by producing tungsten dithiocarbamates in yields which are not viable on a commercial scale.

It has now been unexpectedly discovered that a phosphorus and sulfur free organic tungsten complex according to embodiments of the present invention imparts antiwear, corrosion, and antioxidancy properties upon a lubricating composition. These characteristics are maintained even in lubricant compositions containing reduced phosphorus and sulfur levels.

### SUMMARY OF THE INVENTION

One embodiment of the present invention relates to an organic tungsten complex prepared by reacting a tungsten salt and a fatty acid derivative, wherein the tungsten salt is the reaction product of an acidic tungsten and a nitrogenous base.

The present invention also relates to lubricant compositions having improved antiwear, corrosion, and antioxidancy properties. These compositions contain an organic tungsten complex defined as either the reaction product of a mono- or diglyceride and a tungsten source, or as the reaction product of a secondary amine, a fatty acid derivative, and a tungsten source.

In one aspect of this invention, a sulfur and phosphorus free organic tungsten complex is contained in a lubricating composition, and imparts improved antiwear performance on the lubrication composition, even when said composition contains low to no levels of phosphorus and low to no levels of sulfur.

In another aspect of this invention, a sulfur and phosphorus free organic tungsten complex is contained in a lubricating composition along with a zinc dialkyldithiophosphate (ZDDP). The combination of the organic tungsten complex with ZDDP is synergistic, providing significantly higher antiwear activity than either of the components when used separately in lubricants.

In yet another aspect of this invention, a sulfur and phosphorus free organic tungsten complex is contained in a lubricating composition along with an aminic based antioxidant, such as an alkylated diphenylamine. The combination of the organic tungsten complex with the antioxidant is synergistic, providing significantly higher antioxidant activity than either of the components when used separately in lubricants.

The present invention further relates to a sulfur and phosphorus free organic tungsten complex is contained in a lubricating composition and consequently increasing the corrosion resistance of the lubrication composition

### DETAILED DESCRIPTION OF THE INVENTION

The present invention relates to a lubricating composition containing a majority component of a lubricating base and a minority component of an organic tungsten complex. Lubricating bases to be used in the present invention include base oils for lubricating oils, which are composed of mineral oils, synthetic oils or mixtures thereof, and base greases in which a thickener is compounded in any of the base oils. Mineral oils may be paraffinic or naphthenic. Paraffinic oils may be Group I solvent refined base oils, Group II hydrocracked base oils, and Group III high viscosity index hydrocracked base oils. Synthetic oils may consist of Group IV polyalphaolefin (PAO) type, and Group V synthetic oils, which include diesters, polyol esters, polyalkylene glycols, alkyl benzenes, organic esters of phosphoric acids, and polysiloxanes.

The organic tungsten complex of this invention is the reaction product of a fatty acid derivative and a tungsten salt, wherein the tungsten salt is the reaction product of a tungsten source, particularly an acidic tungsten and a nitrogenous base. In particular the fatty acid derivative is a fatty amide and/or a monoglyceride. The material may be prepared according to methods disclosed for the analogous organomolybdates in U.S. Pat. Nos. 4,889,647, 5,137,647, 5,412,130, and 7,205,423; the disclosures of which are incorporated herein by reference in their entirety.

Due to the complex composition of the product, a specific chemical structure cannot be assigned to the organic tungsten complex. For illustrative purposes, a possible component in the composition of the organic tungsten complex of this invention is presented below in Formula I. This depiction is presented as an aid and not intended to limit the composition of the material.

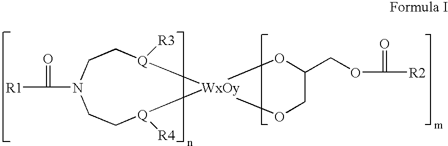

R1 and R2 may represent the same or different fatty oil residue. The preferred fatty oils are glyceryl esters of higher fatty acids containing at least 12 carbon atoms and may contain 22 carbon atoms and higher. Such esters are commonly known as vegetable and animal oils. Vegetable oils particularly useful are oils derived from coconut, corn, cottonseed, linseed, peanut, palm, soybean, rapeseed and sunflower seed. Similarly, animal fatty oils such as tallow may be used.

R3 and R4 may be the same or different, and each may be hydrogen, C1 to C25 straight or branched chain alkyl radicals, C1 to C12 alkoxy-(C6 alkylene) radicals, C2 to C12 alkyl amino-(C2 to C6 alkylene) radicals. Q represents either nitrogen or oxygen. The sum of n+m is a value greater than or equal to 1; x is a value between 1 and 12 and y is a value greater than or equal to x.

The monoglycerides of this invention are readily described in U.S. Pat. Nos. 3,121,059, 4,765,918, 4,889,647, 5,137,647, 5,412,130, 6,500,974, 6,509,303, 6,528,463, 6,645,921, and 6,914,037. The disclosures of which are incorporated herein by reference in their entirety.

In many of these examples, and specifically in U.S. Pat. No. 4,889,647, the monoglyceride is prepared as a co-product of the reaction of a secondary amine with a fatty oil; whereupon the other major product being a fatty alkylamide.

The alkylamides of this invention are readily described in U.S. Pat. Nos. 3,405,064, 4,765,918, 4,889,647, 5,137,647, 5,412,130, 6,103,674, 6,509,303, 6,528,463, 6,645,921, 6,914,037. The disclosures of which are incorporated herein by reference in their entirety.

The tungsten source used for the preparation of the organic tungsten complex of this invention is an ammonium tungstate salt which is the reaction product of an acidic tungstate and a nitrogenous base, giving a compound of the general formula:

[(WO₃)ₓO_{y}H_{z}][NR₅R₆R₇R₈]_{2y-z} Formula II

The ammonium tungstate salt may be represented as a unique composition, where x is a finite value from 1 to 12. Additionally, x may represent a distribution of values in the range of 1 to 12. Consequently, the values of y and z will vary depending upon the value of x, and y will range from 1 to 20, preferably 1 to 5, and z will range from 0 to 20 with z≦y. The preparation of such compounds are well described in literature, as exemplified by Krause et al., Journal of the American Chemical Society, 47, pp. 1689-1694 (1925); Freedman, Journal of the American Chemical Society, 81, pp. 3834-3839 (1959); Keperl, “Isopolytungstates”, Progress in Inorganic Chemistry, Vol. 4, Intersciences Press, New York (1962) p. 199; Comprehensive Inorganic Chemistry, Vol. 3, Bailar et al. eds., Pergamon Press Ltd., Oxford (1973) pp. 763-769; Filowitz et al. Inorganic Chemistry, 18, pp. 93-103 (1979); Errington et al., Journal of the Chemical Society: Chemical Communications, pp 649-651 (1993). Preparations are also described in U.S. Pat. Nos. 3,290,245, 4,278,642, 4,279,870, 4,298,485, and World Patent Applications WO2004/094574 and WO2007/009022.

Tungstates which may be used in the course of preparing the organic tungsten complex of this invention include tungsten compounds in the +4, +5 or +6 oxidation state. Examples of these include, but are not limited to, the tungsten oxides of WO₂ and WO₃, tungstic acid (H₂WO₄) and metal salts thereof, such as Li₂WO₄, Na₂WO₄·2H₂O, K₂WO₄, Cs₂WO₄, MgWO₄, CaWO₄, SrWO₄, BaWO₄, BaCaWO₆, MnWO₄, CoWO₄, CuWO₄, Ag₂WO₄, ZnWO₄, CdWO₄, PbWO₄, and Bi₂(WO₄)₃, ammonium tungstates such as (NH₄)₂WO₄, (NH₄)₁₀[H₂W₁₂O₄₂]·xH₂O, and (NH₄)₆H₂W₁₂O₄₀ xH₂O, halides of tungsten such as WCl₄ WCl₆, WF₆, and WO₂Cl₂, and organotungstates such as W(CO)₆, W(OC₂H₅)₆, WCl₂(OC₂H₅)₃, and W[OCH(CH₃)₂]₆.

Perhaps the only limiting factor on the tungsten source used is cost and availability. Therefore, in this light, preferred tungstates which may be used in the preparation of the organotungstates of this invention are sodium tungstate, sodium metatungstate, sodium polytungstate, ammonium metatungstate, ammonium paratungstate, tungstic acid, tungsten(VI) oxide, calcium tungstate, and hydrates thereof. A most preferred tungstate is one composed of a polynuclear polyoxotungstate anion, containing 2 to 12 tungsten atoms. It would be understood by those skilled in the art, that any of the commercially available tungstates can be readily converted to a polynuclear polyoxotungstate.

Nitrogenous bases used in the preparation of the ammonium tungstate of this invention include monoamines of the general formula:

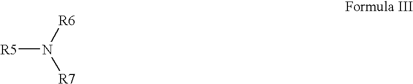

wherein R5, R6 and R7 are hydrogen; i.e. ammonia. The monoamine may also be a primary amine wherein R5 and R6 are hydrogen, and R7 represents linear, branched, saturated or unsaturated alkyl of 1 to 40 carbon atoms that may optionally contain at least one ether moiety, cycloalkyl of 5 to 40 carbon atoms, aryl of 6 to 40 carbon atoms, or aralkyl of 7 to 9 carbon atoms, where the aralkyl is substituted further by alkyl of 1 to 36 carbon atoms. Examples of primary amines useful to this invention are methylamine, isopropylamine, 2-aminoethanol, 3-isopropoxypropylamine, 2-ethylhexyloxypropylamine, Armeen® C (available from Akzo Nobel), Primene™ JM-T (available from Rohm & Hass).

The monoamine may also be a secondary amine, wherein R5 is hydrogen and R6 and R7 independently represent linear, branched, saturated or unsaturated alkyl of 1 to 40 carbon atoms that may optionally contain at least one ether moiety, cycloalkyl of 5 to 40 carbon atoms, aryl of 6 to 40 carbon atoms, or aralkyl of 7 to 9 carbon atoms, where the aralkyl is substituted further by alkyl of 1 to 36 carbon atoms.

The monoamine may be a tertiary amine, wherein R5, R6, and R7 independently represent a C1 to C36 residue that may optionally contain at least one ether moiety, cycloalkyl of 5 to 12 carbon atoms, or aralkyl of 7 to 9 carbon atoms, where the aralkyl is further substituted by alkyl of 1 to 36 carbon atoms.

The monoamine may be a quaternary amine of the formula:

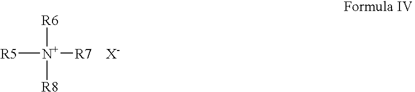

wherein R5, R6, R7 and R8 are independently each a C1 to C36 residue that may optionally contain at least one ether moiety, cycloalkyl of 5 to 12 carbon atoms, or aralkyl of 7 to 9 carbon atoms, where the aralkyl is further substituted by alkyl of 1 to 36 carbon atoms. X represents a counterion and may most commonly be chosen from the group of hydroxide, sulfide, sulfate, hydrogensulfate, fluoride, chloride, bromide or iodide.

Nitrogenous bases used in the preparation of the ammonium tungstate of this invention may include a diamine of the general formula:

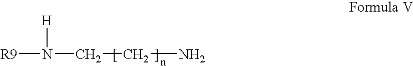

wherein n is 1 to 5 and preferably 1 or 2, and R9 is a hydrocarbon-containing group containing a minimum of about 6 carbon atoms. R9 can be aliphatic or aromatic. In a preferred embodiment, R9 can be represented by the structure X2-O—X1-, wherein X1 is an alky chain of 2 or 3 carbons, and X2 is an alkyl moiety having 3 to 30 carbon atoms, more preferably an alkyl moiety having 7 to 20 carbon atoms, and where X2 can be a straight or branched, saturated or partially unsaturated hydrocarbon chain.

Examples of some mono-substituted diamines according to Formula V that may be used include phenylaminopropylamine, hexylaminopropylamine, benzylaminopropylamine, octylaminopropylamine, octylaminoethylamine, dodecylaminopropylamine, dodecylaminoethylamine, hexadecylaminopropylamine, hexadecylaminoethylamine, octadecylaminopropylamine, octadecylaminoethylamine, isopropyloxypropyl-1,3-diaminopropane, octyloxypropyl-1,3-diaminopropane, decyloxypropyl-1,3-diaminopropane, isodecyloxypropyl-1,3-diaminopropane, dodecyloxypropyl-1,3-diaminopropane, tetradecyloxypropyl-1,3-diaminopropane, isodecyloxypropyl-1,3-diaminopropane, isododecyloxypropyl-1,3-diaminopropane, isotridecyloxypropyl-1,3-diaminopropane. Mono-substituted diamines derived from fatty acids may also be used. Examples include N-coco alkyl-1,3-propanediamine (Duomeen® C), N-tallow alkyl-1,3-propanediamine (Duomeen® T), and N-oleyl-1,3-propanediamine (Duomeen® O), all obtained from Akzo Nobel.

Nitrogenous bases used in the preparation of the ammonium tungstate of this invention may include a diamine of the general formula:

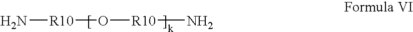

wherein k is an integer from 1 to 10. R10 is a C1 to C6 hydrocarbon-containing group where most commonly R10 contains 2 to 3 carbons. Commercial polyetheramines of this type are available from Huntsman Chemical under the trade name Jeffamine®.

Nitrogenous bases used in the preparation of the ammonium tungstate of this invention may include a polyamine of the general formula:

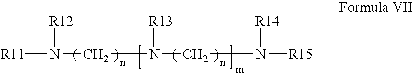

wherein R11 thru R15 may be the same or different, and each may be hydrogen, C1 to C25 straight or branched chain alkyl radicals, C1 to C12 alkoxy-(C6 alkylene) radicals, C2 to C12 alkyl amino-(C2 to C6 alkylene) radicals; each n can be the same or different ranging from 2 to 6 and preferably ranging from 2 to 3 and m is a number from 0 to 10. Examples of such compounds according to Formula VII where m=0 are tetrabutoxy ethanediamine, tetrapropoxy ethanediamine, 1,4-Diazabicyclo[2.2.2]octane, 1,4-Dimethylpiperazine, N,N,N′,N′-Tetramethylethylenediamine, N,N,N′,N′-Tetraacetylethylenediamine, 1,1,4,7,10,10-Hexamethyltriethylenetetramine, N,N,N′,N′-Tetrakis(2-hydroxyethyl)ethylenediamine, N,N,N′,N′-Tetrakis(2-hydroxypropyl)ethylenediamine, ethylenediamine tetracetic acid and derivatives thereof. Examples of compounds where m is greater than 0 are diethylenetriamine, 4,7-Triazacyclononane, tris(2-aminoethyl)amine, tetraethylenepentamine, and pentaethylenehexamine.

Additionally, the sets of [R11, R12] and [R14, R15], may independently represent a cyclic structure, in particular a polyisobutylene succuinimide. Examples of such polyamines are OLOA® 11000, OLOA® 11001, OLOA® 11002, (available from Chevron-Oronite), HiTEC® 644, and HiTEC® 646 (Afton Chemical).

Another class of polyamines applicable to this invention is the polyamine dispersant grafted viscosity index (VI) improvers. The patent literature is full of many examples of the preparation of such compounds. A sampling of these patents, which are hereby incorporated for reference, are U.S. Pat. Nos. 4,089,794, 4,171,273, 4,670,173, 4,517,104, 4,632,769, and 5,512,192. Typical preparation involves pre-grafting olefin copolymers with ethylenically unsaturated carboxylic acid materials to produce an acylated VI improver. The acyl groups are then reacted with polyamines to form carboxylic acid amides and succinimides.

Another class of polyamines applicable to this invention is the Mannich base dispersants. Typical Mannich bases which can be used in this invention are disclosed in U.S. Pat. Nos. 3,368,972, 3,539,663, 3,649,229, and 4,157,309. Mannich bases are typically prepared from alkylphenols having alkyl groups from 9 to 200 carbon atoms, and aldehydes, such as formaldehyde, and polyalkenylamine compounds, such triethylene tetramine, tetraethylene pentamine, and mixtures thereof.

Nitrogenous bases used in the preparation of the ammonium tungstate of this invention may be a triazole of the general formula:

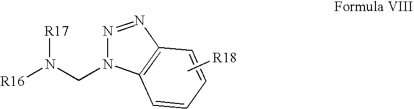

R16 and R17 may be the same or different and may represent hydrogen, C1 to C20 alkyl, C3 to C20 alkenyl, C5 to C12 cycloalkyl, or C7 to C15 arylalkyl. R18 is a hydrogen or a C1 to C20 residue, preferably R18 may be represented by a 4- or 5-methyl radical.

Nitrogenous bases used in the preparation of the ammonium tungstate of this invention may be an imidazoline of the general formula:

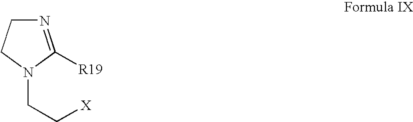

wherein X is a hydroxy or amino group and R19 is an alkyl group or fatty acid residue having 8 to 22 carbon atoms.

The organic tungsten complex of the present invention can be used in combination with other additives typically found in lubricating oil, as well as with other antiwear additives. Typical additives found in lubricating oils are dispersants, detergents, corrosion/rust inhibitors, antioxidants, e.g., secondary amine antioxidants, hindered phenolic antioxidants, sulfur-containing hindered phenolic antioxidants, sulfurized olefins, thiadiazoles, antiwear agents, e.g., zinc dialkyldithiophosphates, antifoamants, friction modifiers, seal swell agents, demulsifiers, VI improvers, and pour point depressants. See, for example, U.S. Pat. No. 5,498,809, incorporated herein by reference, for a description of useful lubricating oil composition additives.

Examples of dispersants include polyisobutylene succinimides, polyisobutylene succinate esters, Mannich Base ashless dispersants, and the like. Examples of detergents include metallic phenates, metallic sulfonates, metallic salicylates, and the like. Examples of friction modifiers that can be used in combination with the friction modifiers of the present invention include fatty acid esters and amides, organomolybdenum compounds, molybdenum dialkylthiocarbamates, molybdenum dialkyldithiophosphates, and the like. An example of an antifoamant is polysiloxane, and the like. An example of a rust inhibitor is polyoxyalkylene polyols, and the like. Examples of VI improvers include olefin copolymers and dispersant olefin copolymers, and the like. An example of a pour point depressant is poly(methyl methacrylate), and the like.

Examples of antioxidant additives that can be used in combination with the additives of the present invention include alkylated diphenylamines and N-alkylated phenylenediamines. Secondary diarylamines are well known antioxidants and there is no particular restriction on the type of secondary diarylamine that can be used in the practice of the present invention. The secondary diarylamine type of antioxidant in a lubricating oil provides a synergistic antioxidant mixture with the additive of the present invention. Preferably, the secondary diarylamine antioxidant is of the general formula R1-NH—R2, where R1 and R2 each independently represent a substituted or unsubstituted aryl group having 6 to 46 carbon atoms. Examples of some secondary diarylamines that can be employed in the practice of the present invention include: diphenylamine, dialkylated diphenylamine, trialkylated diphenylamine, or mixtures thereof, 3-hydroxydiphenylamine, 4-hydroxydiphenylamine, N-phenyl-1,2-phenylenediamine, N-phenyl-1,4-phenylenediamine, mono- and/or di-butyldiphenylamine, mono- and/or di-octyldiphenylamine, mono- and/or di-nonyldiphenylamine, phenyl-.alpha.-naphthylamine, phenyl-.beta.-naphthylamine, di-heptyldiphenylamine, mono- and/or di-(.alpha.-methylstyryl)diphenylamine, mono- and/or di-styryldiphenylamine, N,N′-diisopropyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-diphenyl-p-phenylenediamine, N,N′-di-(naphthyl-2)-p-phenylenediamine, N-isopropyl-N′-phenyl-p-phenylenediamine, N-(1,3-dimethylbutyl)-N′-phenyl-p-phenylenediamine, N-(′-methylpentyl)-N′-phenyl-p-phenylenediamine, N-cyclohexyl-N′-phenyl-p-phenylenediamine, 4-(p-toluenesulfonamido)diphenylamine, 4-isopropoxydiphenylamine, tert-octylated N-phenyl-1-naphthylamino, and mixtures of mono- and dialkylated t-butyl-t-octyldiphenylamines.

Another example of the antioxidant types that can be used in combination with the additives of the present invention is the hindered phenolic type. The hindered phenolic type of antioxidant may provide a synergistic antioxidant mixture with the additives of the present invention in a lubricating oil. As illustrative of oil soluble phenolic compounds, may be listed alkylated monophenols, alkylated hydroquinones, hydroxylated thiodiphenyl ethers, alkylidenebis phenols, benzyl compounds, acylaminophenols, and esters and amides of hindered phenol-substituted alkanoic acids.

Another example of an antioxidant type that can be used in combination with the additives of the present invention includes oil soluble copper compounds, and the like.

Examples of antiwear additives that can be used in combination with the additives of the present invention include organoborates, organophosphites, organic sulfur-containing compounds, zinc dialkyldithiophosphates, zinc diaryldithiophosphates, phosphosulfurized hydrocarbon, and the like. The antiwear agents, in particular zinc dialkyldithiophosphates, provide a synergistic antiwear mixture with the additives of the present invention in a lubricating oil. Additionally, the antiwear agents, together with the secondary diarylamine type antioxidants in a lubricating oil provide a synergistic antioxidant mixture with the additives of the present invention. Suitable phosphates for use as antiwear agents include dihydrocarbyl dithiophosphates, wherein the hydrocarbyl groups contain an average of at least three carbon atoms. Particularly useful are metal salts of at least one dihydrocarbyl dithiophosphoric acid wherein the hydrocarbyl groups contain an average of at least three carbon atoms.

The metals useful to make the phosphate salts include Group I metals, Group II metals, aluminum, lead, tin, molybdenum, manganese, cobalt, and nickel. Zinc is the preferred metal. The preparation of metal phosphorodithioates is well known in the art and is described in a large number of issued patents, including U.S. Pat. Nos. 3,293,181, 3,397,145, 3,396,109, and 3,442,804, the disclosures of which are incorporated herein by reference in their entirety.

Also useful as antiwear additives are amine derivatives of dithiophosphoric acid compounds such as are described in U.S. Pat. No. 3,637,499, the disclosure of which is incorporated herein by reference in its entirety.

The reaction to prepare the organic tungsten complex is accomplished in essentially two phases which may be performed with or without isolation of reaction intermediates. The first step involves functionalization of a fatty oil with a secondary amine, thus producing a fatty amide/glyceride mixture. The fatty amides and glycerides may also be prepared separately; where a fatty acid is reacted with a secondary amine, according to known methods, to produce the fatty amide, and where a triglycerided is hydrolyzed to a monoglyceride followed by purification as exemplified by, but not limited to U.S. Pat. Nos. 6,153,773 and 6,500,974.

The reaction between the fatty oil and secondary amine is typically carried out between 70 and 160° C., and preferably between 100 and 130° C. The reaction times may range from 1 to 8 hours, and are preferably 3 to 5 hours. A reaction solvent may be used as long as it does not react with the fatty oil or secondary amine. Preferred reaction solvents include toluene, xylenes, heptane, and various naphthenic, paraffinic and synthetic diluent oils. There is not particular limit on the volume of solvent used, but for practical purposes, a minimum volume is preferred.

The second phase involves the incorporation of tungsten through the addition of a tungstate salt to the fatty amide, glyceride or fatty amide/glyceride mixture, and the subsequent removal of water and volatile organics from the reaction.

It will be apparent to those skilled in the art that various modifications to reaction conditions, modifications of reagents, and combinations of reagents will achieve the organic tungsten complex of the present invention without departing from the spirit and scope of the present invention. Thus, it is intended that the present invention include modifications and variations that are within the scope of the appended claims and their equivalents.

### EXAMPLE 1

An organic tungsten complex according to an embodiment of the present invention was prepared by the following process. To a reaction vessel was charged 99.84 g of OD-896NT (fatty derivative of 2-(2-aminoethyl)amino-ethanol, available from R.T.Vanderbilt Co. Inc.) and stirred at 60° C. To this, 24.92 g of tungstic acid was added followed by the addition of 25.1 g of a 28.2% ammonium hydroxide solution. Through the restriction of off-gassing, pressure was maintained in the reaction vessel between 1 psi and 2 psi for a period of 30 minutes. The reaction was held at 60° C. for a total of 2.5 hours. It was then stripped of solvent through the slow application of 30 mm Hg of vacuum and simultaneous heating to 120° C.-130° C. The reaction mixture was held under vacuum within this temperature range until all of the solvent and water of reaction were removed. Product was then filtered through diatomaceous earth and recovered as 61.8 g of amber oil. Elemental Analysis; C=60.4%, H=10.9%, N=3.4%, W=7.5% (Ash content as WO₃=9.5%).

### EXAMPLE 2

An organic tungsten complex was prepared as the reaction product of an ammonium tungstate salt and OD-896NT (fatty derivative of 2-(2-aminoethyl)amino-ethanol, available from R.T.Vanderbilt Co.Inc.). The molar ratio of OD-896NT to tungsten was 2:1. The amber oil analyzed as follows: Elemental Analysis; C=63.0%, H=10.8%, N=3.8%, W=9.2% (Ash content as WO₃=11.7%).

### EXAMPLE 3

An organic tungsten complex was prepared as the reaction product of an ammonium tungstate salt and OCD-277 (≧90%ₘₒₗₐᵣ fatty derivative of 2-(2-aminoethyl)amino-ethanol, ≦10%ₘₒₗₐᵣ 1-(2-hydroxyethyl)-2-2-(tall oil alkyl)-2-imidazoline), available from R.T.Vanderbilt Co.Inc.). The molar ratio of OCD-277 to tungsten was 6.5:1. The resulting amber oil analyzed as follows: Elemental Analysis C=64.2%, H=9.1%, N=3.6%, W=6.0% (Ash content as WO₃=7.6%).

### EXAMPLE 4

An organic tungsten complex was prepared as the reaction product of an ammonium tungstate and a glyceryl monostearate (available as Lonzest® GMS from Lonza group Ltd). The molar ratio of glyceryl monostearate to tungsten was 2.9:1. The resulting tan wax analyzed as follows: Elemental Analysis C=69.8%, H=11.4%, N=0%, W=2.2% (Ash content as WO₃=2.8%).

### EXAMPLE 5

An organic tungsten complex was prepared as the reaction product of diethanolamine, oleic acid, and an ammonium tungstate salt. The molar ratio of reactants, relative to tungsten, were 3.5:3.5:1, respectively. The resulting amber oil analyzed as follows: Elemental Analysis C=68.2%, H=10.8%, N=3.6%, W=5.3% (Ash content as WO₃=6.7%).

### EXAMPLE 6

An organic tungsten complex was prepared as the reaction product of isodecyloxypropyl-1,3-diaminopropane, coconut oil, and an ammonium tungstate salt. The molar ratio of reactants, relative to tungsten, were 1:0.55:1, respectively. The resulting red-brown oil analyzed as follows: Elemental Analysis C=54.2%, H=9.2%, N=3.3%, W=20.9% (Ash content as WO₃=27.2%)

### EXAMPLE 7

An organic tungsten complex was prepared as the reaction product of diethanolamine, rapeseed oil, and an ammonium tungstate salt. The molar ratio of reactants, relative to tungsten, were 11.3:6.2:1, respectively. The resulting red-amber oil analyzed as follows: Elemental Analysis C=61.9%, H=10.2%, N=4.8%, W=4.2% (Ash content as WO₃=5.3%).

### EXAMPLE 8

The antiwear properties of an organic tungsten complex of this invention were tested in a lubricating oil composition using a modified Falex Pin & Vee Block Test. In this test, samples were kept under a constant 500 lb jaw load for 60 min. The weights of the Pin and Vee block were measured before and after the test. The difference in weight before and after the test was a measure of wear and was recorded as mg of weight loss in Table 1.

Test samples were prepared by adding the organic tungsten complex of Example 1, to a base oil, Uninap® YNT 100 (manufactured by Unisource Energy, Inc.). Three comparative examples were also prepared: (1) an ashless anti-wear additive which is a diethanolamide derivative of coconut oil (available as OD-896NT from R.T.Vanderbilt Co.Inc.), (2) a ditridecylammonium polyoxotungstate, prepared by the method described in U.S. Patent Application 2004/0214731; although any common method to prepare an alkylammonium tungstate salt, such as those referred to herein, may be employed, (3) an organoborate, which is the reaction product of coconut oil, diethanolamine and a boron source (available under the trade name Vanlube® 289, R.T. Vanderbilt Co. Inc.), and (4) an organomolybdate which is the reaction product of coconut oil, diethanolamine and a molybdenum source (available under the trade name Molyvan® 855, R.T.Vanderbilt Co.Inc.). These test samples contain no phosphorus and no sulfur.

TABLE 1

| | | | | | | | | | Falex Pin& | |
|---|---|---|---|---|---|---|---|---|---|---|
| | | | | | | Organo | | | Vee, lb | |
| | | | Alkyl Ammonium | Organo Borate | Organo Molybdate | Tungstate | | | Load 60 | Time |
| | | | Tungstate Salt | Vanlube ® | Molyvan ® 855 | Example 1 | Metal | Metal | minutes, Mass | to Fail |
| Trial | Base Oil | OD-896 | (29.5% W) | 289 (1% B) | (8.1% Mo) | (7.5% W) | (ppm) | (Moles/Mg) | loss, (mg) | (min) |
| 1a | 100.00% | — | — | — | — | — | — | — | Fail | 1 |
| 1b | 99.75% | 0.25% | — | — | — | — | — | — | Fail | 10 |
| 1c | 99.88% | — | 0.12% | — | — | — | 354 | 1.9 | 15 | — |
| 1d | 99.76% | — | 0.24% | — | — | — | 708 | 3.9 | 5.3 | — |
| 1e | 99.75% | — | — | 0.25% | — | — | 25 | 2.3 | Fail | 36 |
| 1f | 99.50% | — | — | 0.50% | — | — | 50 | 4.6 | 9 | — |
| 1g | 99.56% | — | — | — | 0.44% | — | 356 | 3.7 | 40.5 | — |
| 1h | 99.50% | — | — | — | 0.50% | — | 405 | 4.2 | 31.1 | — |
| 1i | 99.00% | — | — | — | 1.00% | — | 810 | 8.4 | 24.4 | — |
| 1j | 99.87% | — | — | — | — | 0.13% | 98 | 0.5 | Fail | 1.5 |
| 1k | 99.82% | — | — | — | — | 0.18% | 136 | 0.7 | Fail | 17 |
| 1l | 99.77% | — | — | — | — | 0.23% | 174 | 1.0 | 26.5 | — |
| 1m | 99.71% | — | — | — | — | 0.29% | 219 | 1.2 | 2.7 | — |
| 1n | 99.54% | — | — | — | — | 0.47% | 355 | 1.9 | 2.1 | — |
| 1o | 99.00% | — | — | — | — | 1.00% | 756 | 4.1 | 1.4 | — |
| 1p | 97.21% | — | — | — | — | 2.79% | 2109 | 11.5 | 1 | — |

From the above table it is shown that a lubricating composition containing the organic tungsten complex of this invention gives the surprisingly superior result of extremely low wear at very low concentrations, and outperforms the other additives at similar concentrations. In particular, a comparison of Trials 1g and 1n demonstrate that the wear rate for the organomolybdate is in the range of 19 times greater than the wear rate for the organic tungsten complex at similar treat levels. An interesting point is when the compositions are interpreted in view of molar activity rather than weight activity. When ppm values are converted from (g metal)/(1×10⁶ g lubricant) to (moles metal)/(1×10⁶ g lubricant), the metal to wear relationship can be seen more clearly. Trials 1d, 1f, 1h, and 1o all have the relatively similar molar concentrations of 3.9, 4.6, 4.2, and 4.1 (moles metal)/(1×10⁶ g lubricant), respectively. At this concentration, the organic tungsten complex of this invention, has a wear value of 1.4 mg (Trial 1o). The alkylammonium polyoxotungstate (Trial 1d), has a wear value 3.8 times that of the organic tungsten complex. The organoborate (Trial 1f), has a wear value 6.4 times that of the organic tungsten complex, and the organomolybdate (Trial 1h), has a wear value 22.2 times that of the organic tungsten complex.

### EXAMPLE 9

To a lubricant base stock of Uninap® YNT 100 (manufactured by Unisource Energy, Inc.), is added the organic tungsten complex of Example 1, and a zinc dialkyldithiophosphate. Samples were tested for antiwear performance on a Falex Pin & Vee apparatus. Comparative formulations were also prepared using Molyvan® 855 (available from R.T. Vanderbilt Co. Inc.).

Wear synergy of the inventive tungstates with ZDDP was determined by using a modified Falex Pin & Vee Block Test. Samples were kept under a constant 500 lb jaw load for 60 min. The weights of the Pin and Vee block were measured before and after the test. The difference in weight before and after the test was a measure of wear and was recorded as mg of weight loss in Table 2. An antiwear synergy is observed in the system when the weight loss due to wear is less than that expected from the sum of the individual linear responses of each of the antiwear agents.

TABLE 2

| | | | | Organo Molybdate | | | | Falex Pin&Vee, lb | Time to |
|---|---|---|---|---|---|---|---|---|---|
| | | Lubrizol ® | Organo Tungstate | Molyvan ® 855 | | | Metal | Load 60 minutes, Mass | Fail |
| Trial | Base Oil | 1395 ZDDP | Example 1(7.5% W) | (8.1% Mo) | ppm P | Metal (ppm) | (Moles/Mg) | loss, (mg) | (min) |
| 2a | 99.00% | 1.00% | — | — | 950 | 0 | 0 | Fail | 3 |
| 2b | 99.00% | 0.75% | 0.25% | — | 713 | 188 | 1.0 | 2 | — |
| 2c | 99.00% | 0.50% | 0.50% | — | 475 | 377 | 2.1 | 1.1 | — |
| 2d | 99.00% | 0.25% | 0.75% | — | 238 | 565 | 3.1 | 3.9 | — |
| 2e | 99.77% | 0.10% | 0.13% | — | 95 | 98 | 0.5 | 11.2 | — |
| 2f | 99.82% | 0.05% | 0.13% | — | 48 | 98 | 0.5 | Fail | 57.5 |
| 2g | 99.53% | — | 0.47% | — | 0 | 354 | 1.9 | 2.1 | — |
| 2h | 99.56% | — | — | 0.44% | 0 | 354 | 3.7 | 40.5 | — |
| 2i | 99.06% | 0.50% | — | 0.44% | 475 | 354 | 3.7 | 11.3 | — |
| 2j | 99.78% | 0.10% | — | 0.12% | 95 | 98 | 1.0 | 49.4 | — |

The above table demonstrates that a lubricant system containing an organic tungsten complex of this invention and ZDDP shows far superior wear performance to a system containing ZDDP alone. It is also demonstrated that even when ZDDP levels are reduced to less than 100 ppm phosphorus, acceptable levels of wear may be retained with the addition of the organic tungsten complex of this invention. While the combination of ZDDP and an organomolybdate shows a similar trend in behavior, the surprising superiority of the ZDDP, organic tungsten complex combination is unexpected.

### EXAMPLE 10

A lubricant base stock is prepared by blending 96.1% ISO 32, Group II oil and 4.5 wt % dispersant (Infineum® C9268). To this base stock, the organic tungsten complex of Example 1 is combined with an alkylated diphenylamine (ADPA) such that the organic tungsten complex-ADPA combination amounts to 1 wt % of the total blend.

Antioxidant synergy of the inventive tungstates was determined by the Pressure Differential Scanning Calorimetry (PDSC) oxidation test (ASTM D6186@180C). Oxidative stability is measured by the time it takes under isothermal conditions before an exothermic release of heat is observed. An antioxidant synergy is observed in the system when the time to induce an exotherm in the mixture of antioxidants is greater than the time expected from the sum of the individual linear responses of each of the antioxidants.

The behavior of lubricant compositions containing the organic tungsten complex of this invention and commonly used ADPA antioxidants are shown in Tables 3, 4 and 5 below. The ADPA of Table 3 is a butylated-octylated diphenylamine available under the trade name Vanlube® 961 (R.T. Vanderbilt Co. Inc.). The ADPA of Table 4 is an alkylated diphenyl aminomethyl benzotriazole of the structure of >FIG. 8, and is available under the trade name Vanlube® 887 (R.T. Vanderbilt Co. Inc.). The ADPA of Table 5 is a polymerized 1,2-dihydro-2,2,4-trimethylquinoline available under the trade name Vanlube® RD (R.T. Vanderbilt Co. Inc.), or may be prepared as disclosed in U.S. Pat. No. 6,235,686, which is incorporated here in its entirety.

TABLE 3

| | | | | | PDSC @ 180° C.; | | |
|---|---|---|---|---|---|---|---|
| | EM ISO | | Organo Tungstate | | 500 lbs O₂; 100 ml/min | | |
| | 32 Group | Infineum ® C9268 | Example 1 | Vanlube ® 961 | flow; Min. to | Expected Linear | % Increase Over |
| Example | II Oil | Dispersant | (7.5% W) | Antioxidant | induction | Response | Linear Response |
| 3a | 95.14% | 3.86% | 1.00% | 0.00% | 8.3 | 8.3 | 0% |
| 3b | 95.14% | 3.86% | 0.75% | 0.25% | 105.6 | 21.4 | 393% |
| 3c | 95.14% | 3.86% | 0.50% | 0.50% | 132.5 | 34.5 | 284% |
| 3d | 95.14% | 3.86% | 0.25% | 0.75% | 154.6 | 47.6 | 225% |
| 3e | 95.14% | 3.86% | 0.00% | 1.00% | 60.7 | 60.7 | 0% |

TABLE 4

| | EM ISO 32 | | | | PDSC @ 180° C.; | | |
|---|---|---|---|---|---|---|---|
| | Group | Infineum ® C9268 | Organo Tungstate | Vanlube ® 887 | 500 lbs O₂; 100 ml/min | Expected Linear | % Increase Over |
| Trial | II Oil | Dispersant | Example 1 (7.5% W) | Antioxidant | flow; Min. to induction | Response | Linear Response |
| 4a | 95.14% | 3.86% | 1.00% | 0.00% | 8.3 | 8.3 | 0% |
| 4b | 95.14% | 3.86% | 0.75% | 0.25% | 52.8 | 18.7 | 182% |
| 4c | 95.14% | 3.86% | 0.50% | 0.50% | 59.9 | 29.2 | 105% |
| 4d | 95.14% | 3.86% | 0.25% | 0.75% | 49.8 | 39.6 | 26% |
| 4e | 95.14% | 3.86% | 0.00% | 1.00% | 50.0 | 50 | 0% |

TABLE 5

| | | | | | PDSC @ 180° C.; | | |
|---|---|---|---|---|---|---|---|
| | EM ISO 32 | | | | 500 lbs O₂; 100 ml/min | | |
| | Group II | Infineum ® C9268 | Organo Tungstate | Vanlube ® RD | flow; Min. to | Expected Linear | % Increase Over |
| Trial | Oil | Dispersant | Example 1 (7.5% W) | Antioxidant | induction | Response | Linear Response |
| 5a | 95.14% | 3.86% | 1.00% | 0.00% | 8.3 | 8.3 | 0% |
| 5b | 95.14% | 3.86% | 0.73% | 0.27% | 69.2 | 27.7 | 150% |
| 5c | 95.14% | 3.86% | 0.50% | 0.50% | 87.2 | 44.4 | 97% |
| 5d | 95.14% | 3.86% | 0.25% | 0.75% | 117.2 | 62.4 | 88% |
| 5e | 95.14% | 3.86% | 0.00% | 1.00% | 80.4 | 80.4 | 0% |

### EXAMPLE 11

A lubricant base stock is prepared by blending a majority of a polyalphaolefin base stock (Durasyn® 166), with a zinc dialkyldithiophosphate, (Lubrizol® 1395), a polyisobutylene succinimide dispersant (TC 9596A) and an alkylated diphenylamine antioxidant (Vanlube® 961). To this base, the organic tungsten complex of Example 2 was added to give a metal concentration of 700 ppm. Comparative blends were made using an alkylammonium tungstate salt (U.S. Patent Application 2004/0214731), a polyisobutylene succinimide tungstate salt (U.S. Patent Application 2007/0203032), and an organomolybdate ester (Molyvan® 855); each containing a W or Mo concentration of approximately 700 ppm. Their antioxidancy was then tested by PDSC (ASTM D6186@180C). Results are shown in Table 6

TABLE 6

| | | | | | | | | | | PDSC @ |
|---|---|---|---|---|---|---|---|---|---|---|
| | | | | | | | | | | 180° C.; |
| | | | | | Alkyl | Alkyl | | Organo | | 500 lbs O2; |
| | | | | VANLUBE ® | Polyammonium | Ammonium | | Tungstate | | 100 ml/min |
| | Durasyn ® | TC 9596A | Lubrizol ® | 961 | Tungstate | Tungstate | MOLYVAN ® | Example 2 | Metal | flow; Min. to |
| Trial | 166 PAO | Dispersant | 1395 ZDDP | Antioxidant | Salt (8.25% W) | Salt (29.5% W) | 855 | (9.2% W) | (ppm) | induction |
| 6a | 94.00% | 5.00% | 0.50% | 0.50% | — | — | — | — | 0 | 165 |
| 6b | 93.15% | 5.00% | 0.50% | 0.50% | 0.85% | — | — | — | 708 | 196 |
| 6c | 93.76% | 5.00% | 0.50% | 0.50% | — | 0.24% | — | — | 700 | 204 |
| 6d | 93.09% | 5.00% | 0.50% | 0.50% | — | — | 0.91% | — | 704 | 224 |
| 6e | 93.24% | 5.00% | 0.50% | 0.50% | — | — | — | 0.76% | 701 | 253 |

The results show that the lubricating composition containing the organic tungsten complex of this invention shows surprisingly superior antioxidancy to the polyoxotungstate salts. The increased performance over the organomolybdate ester is also unexpected, particularly in view of the fact that based on molar activity, 700 ppm Mo contains 1.9 times more metal than 700 ppm W.

### EXAMPLE 12

To test the anticorrosive nature of the organic tungsten complex of this invention, a lubricating grease composition was prepared by blending a majority of Li-12OH stearate grease with an extreme pressure agent (Vanlube® 972), a molybdenum dialkyl phosphorodithioate friction reducer (Molyvan® L, both available from R.T. Vanderbilt, Co. Inc.) and the organic tungsten complex of Example 1. As a comparative example, a similar formulation was prepared using an organomolybdate (Molyvan® 855). As a consequence of the extreme pressure and friction reducing agents, these formulations contained phosphorus at 300-315 ppm P, and sulfur at 2590-2600 ppm S. Also compared, is the inherent corrosivity of the organic tungsten complex of Example 1 relative to an oil soluble polyoxotungstate salt, which is prepared by the method described in U.S. Patent Application 2004/0214731; although any common method to prepare an alkylammonium tungstate salt, such as those referred to herein, may be employed.

In the ASTM D-130 Copper Strip Corrosion Test a standard copper strip is placed in a test tube containing the test sample and heated at 100° C. for 24 hours. The strips are then evaluated for corrosion by comparing with standard ASTM copper strips. A rating of 1a indicates no corrosivity, 1b indicates slight tarnish, 2e indicates a moderate tarnish with a brassy or gold discoloration, and 4a to 4c denotes corrosion. Results are shown in Table 7.

TABLE 7

| | | Extreme Pressure | Friction Reducer, | | Organo Molybdate | Alkyl Ammonium | | |
|---|---|---|---|---|---|---|---|---|
| | Li—12OH | Agent Vanlube ® | Antioxidant, | Organo Tungstate | Molyvan ® 855 | Tungstate Salt | | Cu Corrosion 24 hrs |
| Trial | Stearate | 972 | Molyvan ® L | (7.5% W) | (8.1% Mo) | (29.5% W) | ppm M | @ 100° C. |
| 7a | 98.50 | 1.00 | 0.50 | — | — | — | 0 | 4a |
| 7b | 98.45 | 1.00 | 0.50 | 0.05 | — | — | 38 | 4a |
| 7c | 98.35 | 1.00 | 0.50 | 0.15 | — | — | 113 | 1b |
| 7d | 98.25 | 1.00 | 0.50 | 0.25 | — | — | 188 | 2e |
| 7e | 98.25 | 1.00 | 0.50 | — | 0.15 | — | 120 | 2e |
| 7f | 98.25 | 1.00 | 0.50 | — | 0.25 | — | 200 | 2e |
| 7g | 100.00 | — | — | — | — | — | 0 | 1a |
| 7h | 99.75 | — | — | 0.25 | — | — | 188 | 1b |
| 7i | 99.75 | — | — | — | — | 0.25 | 704 | 2e |

Trials 7a thru 7c demonstrate the decrease in copper corrosion with the addition of the organic tungsten complex of the present invention. While the organic tungsten complex consistently acts as a corrosion inhibitor in concentrations above 38 ppm W, a preferred range for corrosion inhibition is between 38 ppm W and 188 ppm W. This is a surprisingly unexpected result, particularly in view of the analogous organomolybdate compositions (6e-6f) which neither have this preferred range, nor a 1b rating.

Trials 7g thru 7i in the above Table demonstrate a comparison of the corrosion behavior of the organic tungsten complex of the present invention and ditridecylammonium polyoxotungstate salt. The tungstate salt is shown to be corrosive to the copper strip relative to the organic tungsten complex of this invention. This is a surprisingly unexpected and superior result, particularly in view of the use of tungstate salts as corrosion inhibitors in the patent literature.

While the invention has been explained in terms of its preferred embodiments, it is to be understood that various modifications thereof will become apparent to those skilled in the art. Therefore it is to be understood that the invention disclosed herein is intended to cover such modifications as fall within the scope of the appended claims.

What is claimed is:

1. An organic tungsten complex prepared by reacting (a) a tungsten salt, wherein the tungsten salt is the reaction product of an acidic tungsten and a nitrogenous base; and (b) a fatty acid derivative.

2. The organic tungsten complex according to claim 1 wherein the tungsten salt is an ammonium tungstate salt.

3. The organic tungsten complex according to claim 1 wherein the fatty oil derivative is a reaction product of (a) a secondary amine and (b) a fatty oil or a fatty acid.

4. The organic tungsten complex according to claim 3 wherein the fatty oil derivative is a monoglyceride.

5. The organic tungsten complex according to claim 1 having the formula 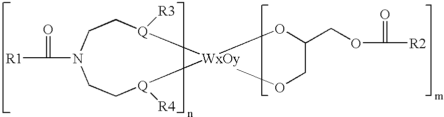
wherein R1 and R2 may represent the same or different fatty oil residue; R3 and R4 may be the same or different, and each may be hydrogen, C1 to C25 straight or branched chain alkyl radicals, C1 to C12 alkoxy-(C6 alkylene) radicals, or C2 to C12 alkyl amino-(C2 to C6 alkylene) radicals; Q represents either nitrogen or oxygen; the sum of n+m is a value greater than or equal to 1; x is a value between 1 and 12; and y is a value greater than or equal to x.

6. The organic tungsten complex according to claim 3 wherein the secondary amine is diethanolamine, 2-(2-aminoethyl)amino-ethanol or isodecyloxypropyl-1,3-diaminopropane.

7. The organic tungsten complex according to claim 4 wherein the monoglyceride is glyceryl stearate.

8. The organic tungsten complex according to claim 3 wherein the fatty oil is selected from the group consisting of tallow, coconut oil, corn oil, cornseed oil, linseed oil, peanut oil, palm oil, soybean oil, rapeseed oil, sunflower seed oil and mixtures thereof.

9. The organic tungsten complex according to claim 2 wherein the nitrogenous base is selected from the group consisting of ammonium metatungstate, ammonium paratungstate, ammonium tungstate and mixtures thereof.

10. The organic tungsten complex according to claim 1 wherein the nitrogenous base is a mono-, di-, or polyamine.

11. The organic tungsten complex according to claim 10 wherein the nitrogenous base is ammonia.

12. The organic tungsten complex according to claim 1 wherein the nitrogenous base is a primary, a secondary, a tertiary or a quaternary amine.

13. The organic tungsten complex according to claim 10 wherein the nitrogenous base is a diamine according to the formula 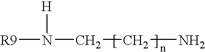
wherein n is 1 to 5, and R9 is a hydrocarbon-containing group having at least 6 carbon atoms.

14. The organic tungsten complex according to claim 10 wherein the nitrogenous base is a polyamine according to the formula 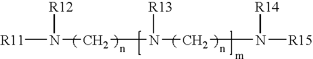
wherein R11 through R15 may be the same or different, and each may be C1 to C25 straight or branched chain alkyl radicals, C1 to C12 alkoxy-(C6 alkylene) radicals, C2 to C12 alkyl amino-(C2 to C6 alkylene) radicals, or sets of R11-R12 and R13-R14 may independently be a cyclic structure; each n can be the same or different ranging from 2 to 6; m is a number from 0 to 10.

15. The organic tungsten complex according to claim 10 wherein the nitrogenous base is a diamine according to the formula 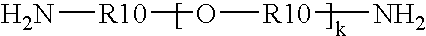
wherein k is a number from 1 to 10 and R10 is a C1 to C6 hydrocarbon containing group.

16. The organic tungsten complex according to claim 10 wherein the nitrogenous base is a polyamine according to the formula 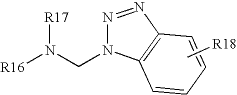
wherein R16 and R17 may be the same or different, and may be hydrogen, C1 to C20 alkyl, C3 to C20 alkenyl, C5 to C12 cycloalkyl, or C7 to C15 arylalkyl; and R18 is a hydrogen or a C1 to C20 residue.

17. The organic tungsten complex according to claim 10 wherein the nitrogenous base is a di- or polyamine according to the formula 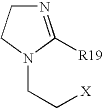
wherein X is a hydroxyl or amino group; and R19 is a C8 to C22 alkyl group or a C8 to C22 fatty acid residue

18. A lubricating composition comprising a major amount of a lubricating oil and about 50 to 50,000 ppm of tungsten provided from an organic tungsten complex, said organic tungsten complex prepared by reacting (a) a tungsten salt, wherein the tungsten salt is the reaction product of an acidic tungsten and a nitrogenous base; and (b) a fatty acid derivative.

19. The lubricating composition according to claim 18 comprising between about 75 to 2500 ppm of tungsten.

20. The lubricating composition according to claim 19 comprising between about 250 to 750 ppm of tungsten.

21. The lubricating composition according to claim 18 further comprising an alkylated diphenylamine and/or an N-alkylated diphenylamine.

22. The lubricating composition according to claim 18 further comprising a metal dialkyldithiophosphate.

23. The lubricating composition according to claim 22 wherein the metal dialkyldithiophosphate is zinc dialkyldithiophosphate.

24. The lubricating composition according to claim 23 wherein the zinc dialkyldithiophosphate is present in an amount of about 0.05 to 5.0 mass percent.

25. The lubricating composition according to claim 24 wherein the zinc dialkyldithiophosphate is present in an amount of about 0.1 to 1.0 mass percent.

26. The lubricating composition according to claim 18 further comprising a secondary diarylamine.

27. The lubricating composition according to claim 21 wherein the alkylated diphenylamine, N-alkylated diphenylamine or secondary diarylamine is present in an amount of about 0.1 to 4.0 mass percent.

28. The lubricating composition according to claim 27 wherein the alkylated diphenylamine is a polymerized 1,2-dihydro-2,2,4-trimethylquinoline or an alkylated diphenyl aminomethyl benzotriazole or a butylated-octylated diphenylamine.

29. The lubricating composition according to claim 23 wherein the mass ratio of zinc dialkyldithiophosphate to the organic tungsten complex is about 100:1 to about 1:10.

30. The lubricating composition according to claim 21 wherein the mass ratio of alkylated diphenylamine to organic tungsten complex is about 75:1 to about 1:3.

31. The lubricating composition according to claim 18 wherein the composition has a sulfur content of 10 mass percent or less.

32. The organic tungsten complex according to claim 1 wherein the complex is substantially sulfur-free and substantially phosphorus-free.

33. The organic tungsten complex according to claim 14 wherein the R11-R12 and R13-R14 cyclic structures are polyisobutylene succinimide.
